(19) United States
(12) Patent Application Publication
(10) Pub. No.: US 2002/0103771 A1
(43) Pub. Date: Aug. 1, 2002

(54) Cost sharing of toll calls

(76) Inventors: Douglas E. Love, Raleigh, NC (US); Valerie V. Blalock, Wake Forest, NC (US); Candace Smith, Durham, NC (US)

Correspondence Address: WITHROW & TERRANOVA, P.L.L.C., P.O. BOX 1287, CARY, NC, 27512, US

(21) Appl. No.: 09/751,088

(22) Filed: Dec. 29, 2000

(51) Int. Cl. G06F 17/60

(52) U.S. Cl. 705/412; 705/1

(57) ABSTRACT

The present invention provides for sharing the cost associated with a toll call between the originating and terminating parties. The parties to the call will agree to the call sharing arrangement and provide parameters defining how to apportion the cost associated with one or a number of toll calls. The toll sharing arrangement may be provided on an ongoing or per-call basis.

### FIELD OF THE INVENTION

The present invention relates to toll calls, and in particular, to apportioning the expense of toll calls among the parties to the toll call.

### BACKGROUND OF THE INVENTION

Charges for toll calls, such as long distance calls, are traditionally billed in full to the originating party. For calls in which the originating party is either unable or unwilling to accept the charges for the toll call, collect calls may be used in which the party terminating the call accepts the charges. In many situations, parties often try to share the cost of toll calls by attempting to alternate the party originating the call, or by apportioning the cost of the call by deciding to terminate the call midway through the conversation and having the terminating party originate a second call to finish the conversation. Such efforts to apportion the cost of toll calls among the parties to the call are cumbersome and inaccurate.

As such, there is a need for an efficient way to share the cost of toll calls among the parties to the call in a simple and efficient manner.

### SUMMARY OF THE INVENTION

The present invention provides for sharing the cost associated with a toll call between the originating and terminating parties. The parties to the call will agree to the call sharing arrangement and provide parameters defining how to apportion the cost associated with one or a number of toll calls. The toll sharing arrangement may be provided on an ongoing or per-call basis.

An ongoing toll sharing arrangement may be configured to apportion costs in any fashion as well as to select certain calls or portions thereof in which to share cost. For example, the parties may agree to share cost for all toll calls between them. Alternatively, the parties may agree to only share the cost of toll calls occurring during a select period, on select days of the week, or after a select time of day. Further, the sharing arrangement may be based on the length of the call or on any number of characteristics associated with the call.

Toll sharing on a per-call basis will preferably require the originator to initiate an automated or operator assisted service capable of contacting and obtaining the approval of the call sharing arrangement with the terminating party. The call sharing parameters may be set by the originating party, the terminating party, or a combination thereof. Preferably, interaction with the parties is provided through traditional communications and telephony equipment, and the apportioning of the toll charges is facilitated by a telephone carrier's billing system alone or in association with a call services system.

In another embodiment, the present invention provides for the terminating party to initiate a toll sharing arrangement for a toll call. The terminating party may initiate an automated or operator assisted service to defer a portion of the cost of the toll call that is traditionally attributed in its entirety to the originating party.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of the specification illustrate several aspects of the invention, and together with the description serve to explain the principles of the invention.

FIG. 1 represents a basic communication environment according to one embodiment of the present invention.

FIG. 2 is a flow diagram outlining a first process for sharing the cost of toll calls according to the present invention.

FIG. 3 is a flow diagram outlining a second process for sharing the cost of toll calls according to the present invention.

FIG. 4 is a block representation of a call service system according to a preferred embodiment of the present invention.

FIG. 5 is a billing system configured according to a preferred embodiment of the present invention.

### DETAILED DESCRIPTION OF THE PREFERRED EMBODIMENTS

The present invention provides for sharing the cost of a toll call among the parties to the call. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims. The embodiments set forth below represent the necessary information to enable those skilled in the art to practice the invention and illustrate the best mode of practicing the invention.

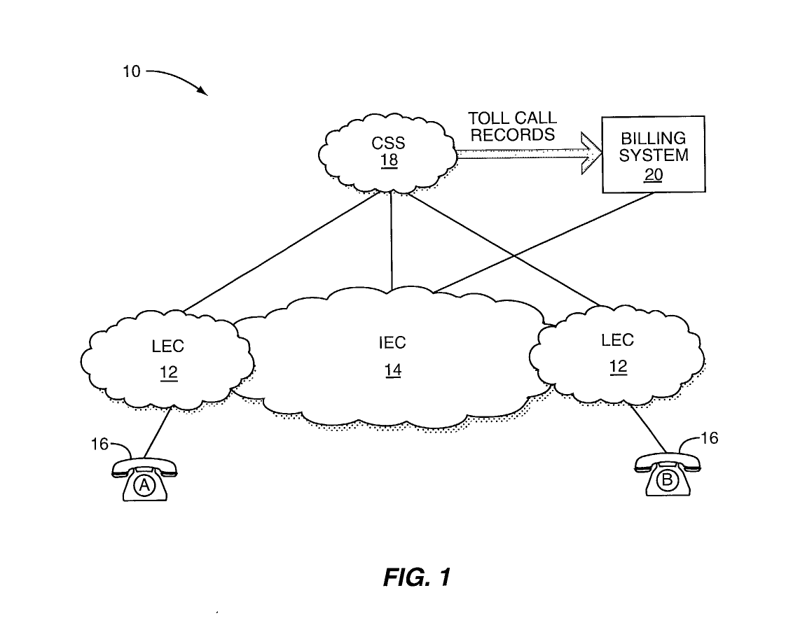

Referring now to FIG. 1 in particular, a communication environment 10 is illustrated including two local exchange carriers (LEC) 12 with an interexchange carrier (IEC) 14 facilitating toll, or long distance, calls between parties serviced by the respective LECs 12. The parties will typically originate and terminate toll calls using telephony devices 16. For purposes of illustration, telephony device 16 “A” originates the call and telephony device 16 “B” terminates the call.

In general, the toll calls between the telephony devices 16 are established via the IEC 14 substantially in traditional fashion. In the present invention, the cost associated with the toll call is apportioned between the originating and terminating parties rather than being completely charged to the originating party as with a standard toll call or to the terminating party as with a collect call. Those skilled in the art are familiar with the establishment and basic billing for toll calls, and the description of the invention will focus on apportioning the cost of toll calls between the parties to the call.

In general, the present invention provides for sharing the cost of toll calls on a per-call basis or provisioning for all or select calls during a defined period of time or on an ongoing basis. Provisioning for sharing of toll call cost provides for the parties to prearrange a sharing arrangement and register with a service provider, wherein subsequent calls between the parties are subject to the call sharing arrangement. Alternatively, sharing of toll call costs on a per-call basis will generally require the assistance of operator or special feature services. Regardless of the implementation of the invention, current telephony systems include the necessary infrastructure to facilitate the present invention. However, new and dedicated systems may be provided to facilitate the invention, as those skilled in the art will recognize.

In general, a call services system (CSS) 18, such as an operator services system or an automated accounting and billing system, may be provided to cooperate with the LECs 12, IEC 14, and associated billing system 20 to facilitate implementation of the present invention. When the sharing of toll call costs is pre-provisioned, information provided for a toll call is sent from the IEC 14 to the billing system 20 in traditional fashion. The billing system 20 may be specially configured to recognize whether or not the cost associated with the toll call is to be shared among the parties to the call and billed accordingly.

When the cost of the toll call is shared on a per-call basis, the CSS 18, alone or in association with an operator (not shown), will recognize a request to share the cost of the toll call and coordinate an interaction with the terminating party to determine whether cost sharing is acceptable to the terminating party. If sharing is acceptable to the terminating party, the CSS 18 will allow establishment of the call and send information relating to the call to the billing system 20. Further detail is provided below, wherein the process for pre-provisioning the sharing of toll call cost is described followed by sharing on a per-call basis.

Parties who frequently communicate with each other may arrange to share the cost of toll calls in virtually any fashion. The degree of control and flexibility in configuring the apportioning of cost is limited only by the configuration of the billing system 20. Assuming that the billing system 20 is configured to provide great flexibility to the parties desiring to share the cost of toll calls, any number of sharing arrangements may be possible. A basic example would split the cost of each call by billing the parties according to a select percentage. The percentage could be equal (50/50) or adjusted to favor one party or the other (e.g. 25/75 or 90/10). The parties may also select certain times in which sharing will occur or arrange for different percentages based on when the call occurs or who originated the call.

Further, sharing may be set up to continue in perpetuity or to have a select start and stop date. Within any of these timeframes, cost sharing may break down into select periods of the day, week, month, year, or any combination thereof. Sharing may also be related to the length of the call, wherein the percentage of the cost apportioned to the parties may vary or the cost associated with the call may switch based on the length of the call. For example, the parties may agree that the originating party will pay for the first ten minutes wherein the terminating party will be apportioned the cost for the call after the first ten minutes. Those skilled in the art will recognize the tremendous flexibility in accommodating cost sharing arrangements.

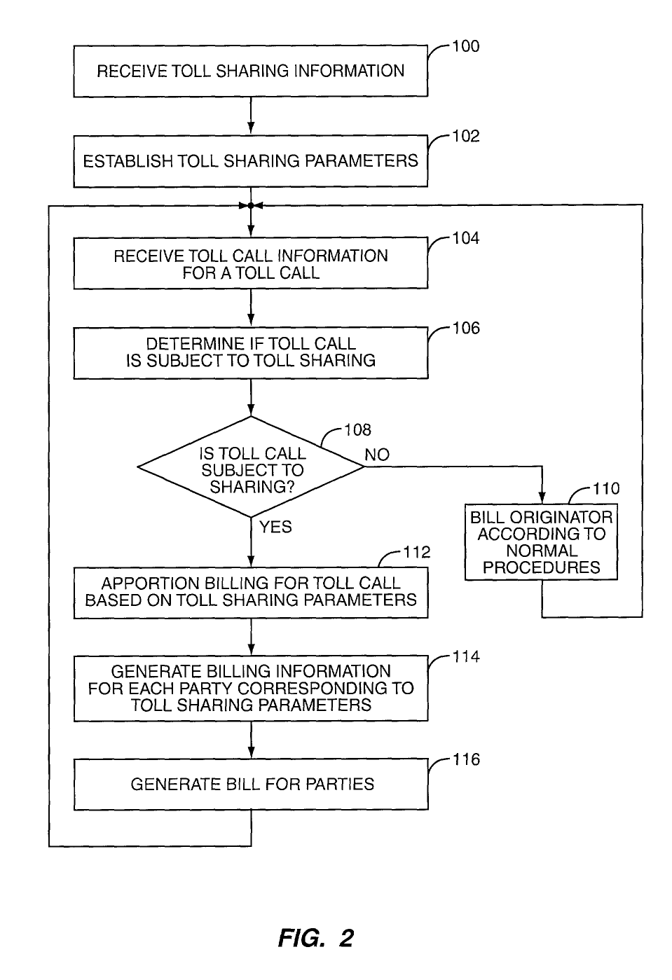

FIG. 2 provides a basic process flow for establishing a cost sharing agreement on an ongoing basis or for a select period of time. The billing system 20 or like system will receive toll sharing information from the parties (block 100) determinative of the agreement between the parties. The toll sharing information is sufficient to allow the billing system 20 to establish toll sharing parameters (block 102) to apply to calls between the parties. At this point, the provisioning for the billing system 20 is complete.

Upon completion of toll calls, the IEC 14 or like service provider will provide toll call information to the billing system 20 for the toll calls (block 104). Preferably, the toll call information is provided to the billing system 20 in the form of toll call records associated with each toll call in traditional fashion.

The billing system 20 will next determine if each toll call is subject to the toll sharing parameters established by the parties (block 106). Such a determination is preferably made by determining whether or not there is a toll sharing agreement between the parties subject to the toll call, and if the parties are subject to a toll sharing agreement, whether the parameters associated with the toll call fall within the toll sharing agreement. For example, if the parties have agreed to share toll calls between 7:00 p.m. and 10:00 p.m., a 5:00 p.m. toll call will not be subject to toll sharing, wherein an 8:00 p.m. toll call would be subject to toll sharing.

If the toll call does not fall within the toll sharing agreement (block 108), the originator is billed according to normal procedures (block 110) and the process repeats. If the toll call is subject to the toll sharing parameters (block 108), the billing system 20 will apportion billing for the toll call based on the toll sharing parameters according to the agreement between the parties (block 112). The billing system 20 will next generate billing information for each party corresponding to the toll sharing parameters (block 114) and generate a bill for each of the parties (block 116). In essence, the toll sharing parameters are the guidelines for the toll sharing agreement between the parties. The process will repeat for each toll call record sent to the billing system 20.

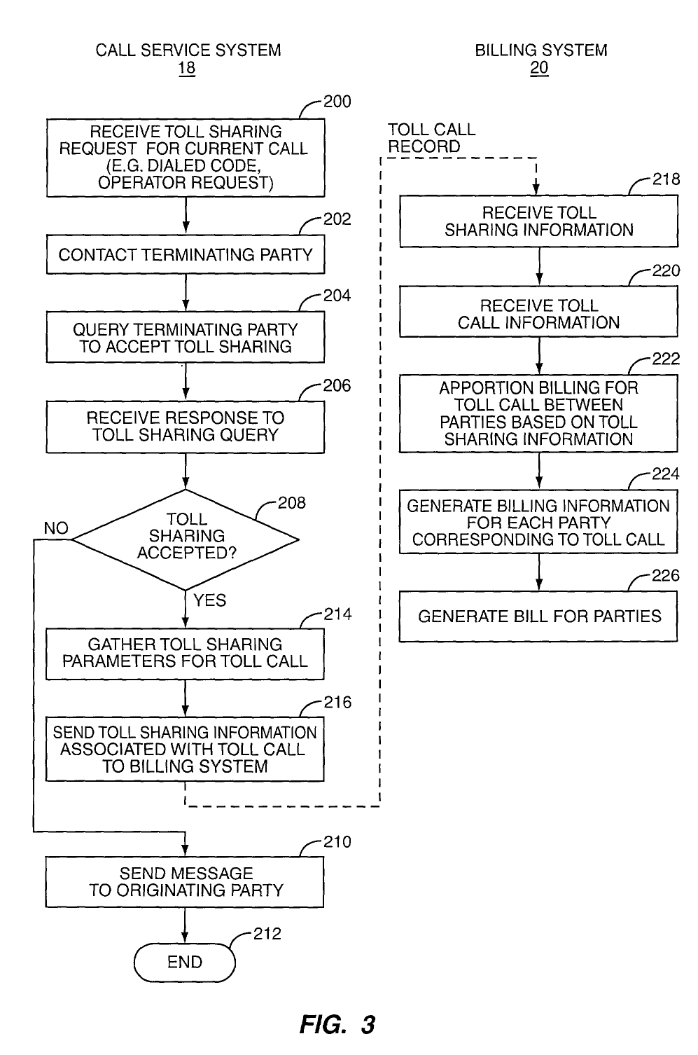

FIG. 3 outlines an exemplary process for sharing the cost of toll calls on a per-call basis. In such a system, there is usually a need to receive permission from the terminating party in order to apportion part of the cost associated with the toll call to the terminating party. The communication system 10 will likely need to facilitate an interaction with the terminating party to gain the terminating party's permission for billing. In the preferred embodiment, the CSS 18 may provide the necessary interaction with the terminating party. The interaction may be completely automated or require the assistance of an operator. Further, the service may be initiated by dialing a feature code or simply dialing a number to contact an operator or initiating operator assisted services, as when in making a collect call.

Assuming that the CSS 18 is capable of facilitating this function alone or in association with an operator, the CSS 18 will receive a toll sharing request associated with the initiation of a current call (block 200). The CSS 18 will initiate contact with the identified terminating party (block 202) and query the terminating party to accept a toll sharing agreement with the originating party (block 204). Those skilled in the art will recognize that the contact and formation of a query to the terminating party may be facilitated by any number of devices in the communication network, such as an intelligent peripheral or like intelligent network (IN) device capable of facilitating automated interaction with parties via a telephony device 16.

The terminating party will provide a response to the query, which is forwarded or otherwise provided to the CSS 18. The CSS 18 will receive the response (block 206), which is determinative of whether toll sharing is acceptable. If toll sharing was not accepted by the terminating party (block 208), the CSS 18 will have a message sent to the originating party indicating the terminating party did not accept the toll sharing arrangement (block 210), and the process ends (block 212).

If the toll sharing arrangement was acceptable by the terminating party (block 208), the CSS 18 may gather toll sharing parameters for the toll call from either or both of the parties (block 214). Although it is preferable to minimize the time and processing resources necessary to establish a toll sharing arrangement, the sharing arrangement may take virtually any form, as described above. The CSS 18 will then send the toll sharing information associated with the toll call to the billing system 20 (block 216), preferably upon completion of the call, in the form of a toll call record. The billing system 20 will receive the toll sharing information (block 218) as well as information pertaining to the toll call itself (block 220). The billing system 20 will then apportion billing for the toll call between the parties based on the toll sharing information (block 222). Billing information is generated for each party corresponding to the toll call (block 224), and the billing system 20 generates a bill for each of the parties (block 226). Billing for toll call sharing will preferably appear on each party's regular billing statement and may be annotated to indicate that the call is subject to a toll sharing arrangement. The process will repeat when activated.

As noted, the CSS 18 may be an operator services system, which provides automated operator services or cooperates with an actual operator. In either case, the automated system or the operator will receive preliminary information that a call sharing arrangement for a call is desired and interact with the originating and terminating parties as necessary to establish the call sharing agreement. The information relating to the call sharing agreement may be transferred to the billing system 20 in any number of ways before, during or after the call. The toll call information is generally sent to the billing system 20 from the IEC 14, wherein the toll call and the sharing agreement associated with the toll call are processed to apportion the cost of the call according to the sharing agreement. The invention is well suited for fully automated processing and does not require human assistance, although human assistance may be provided.

Another feature of the present invention provides for the terminating party to unilaterally initiate call sharing for a toll call. At any point during a call, but preferably upon completion of the toll call, the terminating party may dial an operator or a select feature code to cause the billing system 20 to apportion part of the cost of the previous toll call to the terminating party. This aspect of the invention is envisioned not to require approval from the originating party; however, the CSS 18 may be involved to initiate contact with the originating party to obtain the originating party's consent or simply alert the originating party that the terminating party has elected to take certain billing responsibility for the toll call. Billing for this scenario may include simply apportionating the cost for the toll call as the billing record is created or providing a credit to the originating party and billing the terminating party.

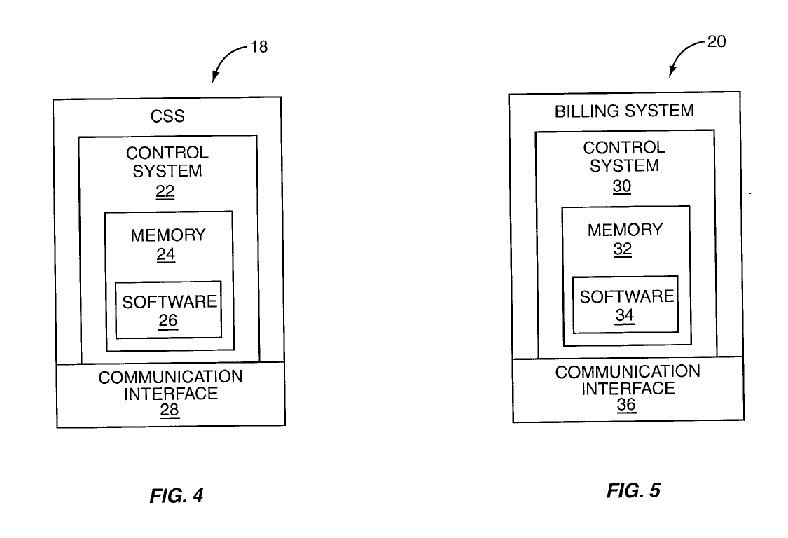

The CSS 18 and billing system 20 may take on various configurations to provide the computational functions described above. As shown in FIG. 4, the CSS 18 will preferably include a control system 22 having sufficient memory 24 containing the requisite software 26 for controlling operation of the system. The control system 22 will cooperate with a communication interface 28 to facilitate communications, preferably over a packet-switched network, with the billing system 20 and the various LECs 12, IEC 14 and related systems to facilitate the operation described above.

Similarly, the billing system 20 will include a control system 30 having memory 32 and the requisite software 34 to facilitate the cost sharing aspects of the present invention. The billing system 20 will also include a communication interface 36 to facilitate communications with the CSS 18 or directly with systems within the LECs 12 or IEC 14 as desired.

Those skilled in the art will recognize that the present invention provides for an efficient and readily accessible way to apportion the cost of toll calls among parties to the toll call. Those skilled in the art will also recognize that the aspects of the invention may be applied to any number of parties to a call and across numerous carriers. Toll calls may take place solely within a carrier or across multiple carriers as described in association with the description of the preferred embodiments. Further, those skilled in the art will recognize modifications and alternatives to the cost sharing arrangements described herein. All such additions and modifications are considered within the scope of the disclosure and the claims that follow.

What is claimed is:

1. A method for sharing costs associated with toll calls comprising:
a) providing toll sharing parameters for a toll call between parties;
b) receiving toll call indicia sufficient to determine costs associated with a toll call; and
c) apportioning the costs for the toll call between the parties based on the toll sharing parameters.

2. The method of claim 1 further comprising generating billing information for each party including apportioned charges for the toll call.

3. The method of claim 1 wherein the providing step further includes receiving information sufficient to define the toll sharing parameters for the toll calls between the parties and defining the toll sharing parameters to apply to the toll calls between the parties.

4. The method of claim 3 further comprising determining whether to apportion costs for the toll call based on the toll call indicia and wherein the apportioning step is applied when the costs associated with the toll call should be apportioned between the parties.

5. The method of claim 4 wherein the determining step further includes determining if the toll call is between the parties for which the toll sharing parameters are defined such that only costs for calls between the parties are apportioned.

6. The method of claim 5 wherein the determining step further includes determining if the toll call falls within the toll sharing parameters such that only costs for calls between the parties and falling within the toll sharing parameters are apportioned.

7. The method of claim 3 wherein the toll sharing parameters are defined to apply to any toll calls occurring after the toll sharing parameters are defined.

8. The method of claim 3 wherein the toll sharing parameters are defined to apply to any toll calls occurring within a defined period of time.

9. The method of claim 8 wherein the toll sharing parameters are defined to apply to any toll calls occurring on or within at least one of the group consisting of time of day, day, week, month, and year.

10. The method of claim 3 wherein the toll sharing parameters are defined to apply to at least one portion of the toll call.

11. The method of claim 3 wherein the toll sharing parameters are defined to apply to at least one portion of the toll call having a defined length.

12. The method of claim 1 further comprising:
a) receiving a request from an originating one of the parties to apportion costs for the toll call;
b) effecting a query to a terminating one of the parties to accept apportioned costs for the toll call;
c) receiving a response to the query from the terminating one of the parties; and
d) determining if the terminating one of the parties is willing to accept apportioned costs for the toll call based on the response to the query.

13. The method of claim 12 further comprising facilitating interaction with the originating one of the parties to provide the toll sharing parameters for the toll call.

14. The method of claim 12 further comprising facilitating interaction with the terminating one of the parties to provide the toll sharing parameters for the toll call.

15. The method of claim 12 wherein the request is a code dialed by the originating one of the parties configured to initiate cost sharing for the toll call.

16. The method of claim 12 wherein the request is made via operator assistance to initiate cos t sharing for the toll call.

17. The method of claim 1 wherein the toll call indicia is received from a carrier facilitating the toll call.

18. A system for sharing costs associated with toll calls comprising a control system adapted to:
a) provide toll sharing parameters for a toll call between parties;
b) receive toll call indicia sufficient to determine costs associated with a toll call; and
c) apportion the costs for the toll call between the parties based on the toll sharing parameters.

19. The system of claim 18 wherein said control system is further adapted to generate billing information for each party including apportioned charges for the toll call.

20. The system of claim 18 wherein said control system is further adapted to receive information sufficient to define the toll sharing parameters for the toll calls between the parties and define the toll sharing parameters to apply to the toll calls between the parties.

21. The system of claim 20 wherein said control system is further adapted to determine whether to apportion costs for the toll call based on the toll call indicia and apportion the costs for the toll call when the costs associated with the toll call should be apportioned between the parties.

22. The system of claim 21 wherein said control system is further adapted to determine if the toll call is between the parties for which the toll sharing parameters are defined such that only costs for calls between the parties are apportioned.

23. The system of claim 22 wherein said control system is further adapted to determine if the toll call falls within the toll sharing parameters such that only costs for calls between the parties and falling within the toll sharing parameters are apportioned.

24. The system of claim 20 wherein the toll sharing parameters are defined to apply to any toll calls occurring after the toll sharing parameters are defined.

25. The system of claim 20 wherein the toll sharing parameters are defined to apply to any toll calls occurring within a defined period of time.

26. The system of claim 25 wherein the toll sharing parameters are defined to apply to any toll calls occurring on or within at least one of the group consisting of time of day, day, week, month, and year.

27. The system of claim 20 wherein the toll sharing parameters are defined to apply to at least one portion of the toll call.

28. The system of claim 20 wherein the toll sharing parameters are defined to apply to at least one portion of the toll call having a defined length.

29. The system of claim 18 wherein said control system is further adapted to:
a) receive a request from an originating one of the parties to apportion costs for the toll call;
b) effect a query to a terminating one of the parties to accept apportioned costs for the toll call;
c) receive a response to the query from the terminating one of the parties; and
d) determine if the terminating one of the parties is willing to accept apportioned costs for the toll call based on the response to the query.

30. The system of claim 29 wherein said control system is further adapted to facilitate interaction with the originating one of the parties to provide the toll sharing parameters for the toll call.

31. The system of claim 29 wherein said control system is further adapted to facilitate interaction with the terminating one of the parties to provide the toll sharing parameters for the toll call.

32. The system of claim 29 wherein the request is a code dialed by the originating one of the parties configured to initiate cost sharing for the toll call.

33. The system of claim 29 wherein the request is made via operator assistance to initiate cost sharing for the toll call.

34. The system of claim 1 wherein the toll call indicia is received from a carrier facilitating the toll call.

35. A computer readable medium including software for sharing costs associated with toll calls, the software comprising computer instructions to:
a) provide toll sharing parameters for a toll call between at least two parties;
b) receive toll call indicia sufficient to determine costs associated with a toll call; and
c) apportion the costs for the toll call between the parties based on the toll sharing parameters.

36. The computer readable medium of claim 35 further comprising instructions to generate billing information for each party including apportioned charges for the toll call.

37. The computer readable medium of claim 35 further comprising instructions to receive information sufficient to define the toll sharing parameters for toll calls between the parties and define the toll sharing parameters to apply to toll calls between the parties.

38. The computer readable medium of claim 37 further comprising instructions to determine whether to apportion costs for the toll call based on the toll call indicia and apportion the costs for the toll call when the costs associated with the toll call should be apportioned between the parties.

39. The computer readable medium of claim 38 further comprising instructions to determine if the toll call is between the parties for which the toll sharing parameters are defined such that only costs for calls between the parties are apportioned.

40. The computer readable medium of claim 39 further comprising instructions to determine if the toll call falls within the toll sharing parameters such that only costs for calls between the parties and falling within the toll sharing parameters are apportioned.

41. The computer readable medium of claim 37 wherein the toll sharing parameters are defined to apply to any toll calls occurring after the toll sharing parameters are defined.

42. The computer readable medium of claim 37 wherein the toll sharing parameters are defined to apply to any toll calls occurring within a defined period of time.

43. The computer readable medium of claim 42 wherein the toll sharing parameters are defined to apply to any toll calls occurring on or within a t least one of the group consisting of time of day, day, week, month, and year.

44. The computer readable medium of claim 37 wherein the toll sharing parameters are defined to apply to at least one portion of the toll call.

45. The computer readable medium of claim 37 wherein the toll sharing parameters are defined to apply to at least one portion of the toll call having a defined length.

46. The computer readable medium of claim 35 further comprising instructions to:
a) receive a request from an originating one of the parties to apportion costs for the toll call;
b) effect a query to a terminating one of the parties to accept apportioned costs for the toll call;
c) receive a response to the query from the terminating one of the parties; and
d) determine if the terminating one of the parties is willing to accept apportioned costs for the toll call based on the response to the query.

47. The computer readable medium of claim 46 further comprising instructions to facilitate interaction with the originating one of the parties to provide the toll sharing parameters for the toll call.

48. The computer readable medium of claim 46 further comprising instructions to facilitate interaction with the terminating one of the parties to provide the toll sharing parameters for the toll call.

49. The computer readable medium of claim 46 wherein the request is a code dialed by the originating one of the parties configured to initiate cost sharing for the toll call.

50. The computer readable medium of claim 46 wherein the request is made via operator assistance to initiate cost sharing for the toll call.

51. The computer readable medium of claim 35 wherein the toll call indicia is received from a carrier facilitating the toll call.

52. A method of sharing a cost of a toll call between an originating party and a terminating party:
a) generating a toll sharing agreement between the originating and terminating parties to apportion the cost of the toll call according to defined parameters;
b) determining the cost of the toll call; and
c) apportioning the costs of the toll call among the originating and terminating parties according to the defined parameters.

53. A method for sharing costs associated with toll calls comprising:
a) receiving a request from a terminating party to apportion costs for a toll call with an originating party;
b) providing toll sharing parameters for the toll call;
c) receiving toll call indicia sufficient to determine costs associated with a toll call; and
d) apportioning the costs for the toll call between the parties based on the toll sharing parameters.
